(19) United States
(12) Patent Application Publication
(10) Pub. No.: US 2025/0055921 A1
(43) Pub. Date: Feb. 13, 2025

(54) METHOD FOR DATA TRANSFER IN A NETWORK SYSTEM, AND NETWORK SYSTEM

(71) Applicant: dSPACE GmbH, Paderborn (DE)

(72) Inventors: Stephan SCHEDLER, Paderborn (DE); Hendrik KASSNER, Paderborn (DE)

(73) Assignee: dSPACE GmbH, Paderborn (DE)

(21) Appl. No.: 18/744,497

(22) Filed: Jun. 14, 2024

(30) Foreign Application Priority Data
Aug. 9, 2023 (EP) 23190448.3

(51) Int. Cl. H04L 67/141; H04L 69/08

(52) U.S. Cl. CPC H04L 67/141; H04L 69/08

(57) ABSTRACT

A computer-implemented method for data transfer in a network system comprising an external network and an internal network. The external network including at least one first network element and an external network communication element. The internal network including at least one second network element and an internal network communication element. The second network element being designed to communicate solely within the internal network. The data to be sent is encoded and transferred to the external network communication element. The data is transferred to the internal network communication element via the IP communication channel and decoded. The data is re-encoded into an application layer by the internal network communication element and transferred to the second network element.

This nonprovisional application claims priority under 35 U.S.C. § 119 (a) to European Patent Application No. 23190448.3, which was filed on Aug. 9, 2023, and which is herein incorporated by reference.

### BACKGROUND OF THE INVENTION

### Field of the Invention

The present invention relates to a method for data transfer in a network system. The present invention further relates to a corresponding network system.

### Description of the Background Art

A conventional user network node-target network node scenario without the presence of a cluster is normally made up of a single user network node (consumer client), such as a browser on a desktop PC which requests download of a service such as an HTML page, and a target network node (service provider), for example a web server, that provides the requested service.

The consumer client and the service provider host the corresponding applications, and are connected to the same network via Ethernet interfaces, for example “eth0.” To allow use of the service, the consumer client must know the service address, which is made up of the IP address of the service provider, for example 192.168.0.1, and a service port, for example 80 for HTTP connections or 443 for HTTPS connections.

The port is necessary for identifying the service application that is operated on the service provider. To allow receipt of responses from the service provider, the consumer client has a dedicated consumer IP address and listens on the consumer port.

For this purpose, the service provider normally uses a predefined static port, since this port must be known to each consumer client in order to initiate a connection. In contrast, the consumer port may have a dynamic setup, since it can be made known to the service provider upon the first connection request by the consumer client.

The basic concept of cloud computing is to instantiate hundreds or even thousands of service applications on demand, each of which runs encapsulated in a runtime environment, for example a container or a virtual machine. A common example of such a service application is a web server application that listens for HTTP requests or HTTPS requests on a predefined port.

Alternatively, within the scope of a second consumer provider scenario, for example the provider may be operated in another (sub) network. The two nodes no longer have a direct connection; i.e., the consumer client cannot reach the service provider directly, and vice versa. A simple example of such a setup is a cluster in which the service provider is instantiated in the cluster and the consumer client is operated outside the cluster.

The two nodes are connected to different networks, referred to below as internal networks and external networks. There is an access node which has access to both networks, the cluster-internal network and the cluster-external network. Instead of sending a service request to the target IP and to the service port, the initial connection request by the consumer client is sent to the IP and to the access port of the access node, and from there is sent to the IP and to the access port of the cluster node or of the service provider.

The service provider is configured in such a way that it provides the service to the external network at the access port; i.e., each request by the consumer client of the external network at the access point is relayed to the service port of the target network node in the internal network.

In the two application scenarios mentioned above, the first connection request is directed to a static (known) port. In the first application scenario, further dynamically assigned ports may be used in the subsequent communication. For this purpose, new ports of applications on the provider may be dynamically assigned. The existing, initial communication path may be utilized to signal to the consumer client the availability of the new ports and the associated services.

However, in the second application scenario, the provision of the services in a cloud environment, this is not possible. Even if new ports can be dynamically assigned by the service provider, they are not accessible from the external network. The opening up of ports, i.e., a port relay, normally requires a static configuration, so that the ports must all be known in advance.

This problem is not relevant for service applications that are designed to be executed in a cluster. However, if there is an existing application that uses dynamic ports, the need to port the application from the first application scenario into the second application scenario (providing the services in a cloud environment) may entail considerable costs.

According to further known methods, complete network packets in a provider-side tunnel client are “sniffed” and transferred via a tunnel. The packets are then corrected; i.e., the destination IP and the IP check sum are adapted, and ultimately are re-output as raw data packets (raw frames) into the internal network of the provider. Only the Ethernet header and the IP header of the frame are analyzed. However, the payloads of the superordinate protocols (TCP/UDP) are not decoded.

However, this results in a rights (capability) problem. During sniffing in such a promiscuous mode, the local Ethernet stack of such a tunnel server node must be deactivated so that a tunnel server application can control the entirety of the Ethernet traffic. This is necessary, since otherwise the undeactivated Ethernet stack of the tunnel server node would respond to and reject packets, although they are supposed to be transferred to the tunnel client.

At the present time it is not possible, using common container orchestration software such as Kubernetes, to operate applications that require a dynamic port assignment, when the dynamic port must be reachable from outside the cluster.

### SUMMARY OF THE INVENTION

It is therefore an object of the invention to provide a method for data transfer in a network system, and a corresponding network system, which allow applications that require a dynamic port assignment to be operated in a user right-restricted cluster environment.

In a first aspect, the invention relates to a computer-implemented method for data transfer in a network system comprising an external network and an internal network. The external network includes at least one first network element and an external network communication element. The external network communication element is designed to monitor the external network. The internal network can include at least one second network element and an internal network communication element. The second network element is designed to communicate solely within the internal network. The external network communication element and the internal network communication element are communicatively connected to one another via an IP communication channel.

The method comprises the following steps: encoding, by the first network element, the data to be sent; transferring the encoded data from the first network element to the external network communication element; decoding the data by the external network communication element and transferring the data from the external network communication element to the internal network communication element via the IP communication channel; or transferring the data from the external network communication element to the internal network communication element via the IP communication channel and decoding the data by the internal network communication element; re-encoding the data into an application layer by the internal network communication element; transferring the re-encoded data from the internal network communication element to the second network element; and decoding the data by the second network element.

The internal network may in particular be a cluster network or an intranet. It is differentiated from the external network in that the elements of the internal network do not have all the rights to communicate with devices outside the internal network.

Specific requirements or communication restrictions that are not precluded by the invention may also exist in the external network, but are not necessary for the proposed method. The external network may therefore be any given network, for example the internet or a local, in particular open, network.

The first network element may, for example, be a browser on a desktop PC that requests a service such as downloading of an HTML page.

In contrast, the second network element may be the counterpart to the first network element, and offers a service such as providing an HTML page for downloading.

The first and the second network communication elements are configured to communicate with one another via an IP communication channel. The IP communication channel is not necessarily an IP tunnel.

An IP tunnel is a network communication channel of the internet protocol between two networks. It is used to transport a different network protocol by encapsulating its packets. In IP tunneling, each IP packet, including the address information of its source and target IP networks, is enveloped in another packet format that is native for the transit network. Complete Ethernet frames are transferred, but this is not necessary according to the present invention.

According to the present invention, the internal network communication element must not possess expanded rights (capabilities). Thus, neither a conventional VPN connection, nor an approach that uses a provider-side promiscuous mode, for example, is implemented.

The present invention avoids the rights problem for the internal network communication element, in that the Ethernet stack of the internal network communication element is not deactivated. Instead, the internal network communication element mirrors the behavior of the first network element in the internal network by sending all service requests from the first network element to the second network element. For this purpose, the raw data packets are preferably decoded up to the UDP/TCP layer, i.e., to the payload of this layer. When the external or the internal network communication element has decoded the UDP/TCP payload, it can make requests to the first network element, using this payload itself.

The term “UDP/TCP layer” refers in particular to the ISO/OSI reference model or the TCP/IP reference model.

The ISO/OSI reference model is a reference model for network protocols as layered architecture. It defines seven successive layers, each with narrowly limited tasks. Network protocols that are defined in the same layer with clear interfaces are easily interchangeable, even if they, like the internet protocol, have a central function.

The TCP/IP reference model is the foundation of the internet protocol family. For the internet and the internet protocol family, the model describes a breakdown into four layers built up in succession. This model is tailored to the internet protocols which allow the data exchange beyond the limits of local networks. These include in particular TCP and IP. Neither the access to a transfer medium nor the data transfer technique is defined in the model. Rather, the internet protocols are responsible for relaying data packets along multiple point-to-point connections (hops), and on this basis, establishing connections between network users via multiple hops.

The special feature of the present invention lies in the fact that there is no direct communication channel between the first network element and the second network element. Nevertheless, the data are not tunneled from the first external network into the internal network, as would be the case when using a VPN connection, for example. Rather, the internal network communication element forms a communication user that sends the raw data of the first network element to the second network element.

The external network communication element intercepts any request that is actually made to the second network element, in particular a provider offering a service. The intercepted data are decoded by one of the network communication elements and then re-encoded within the internal network.

Within the scope of the present invention, the term “re-encoding” refers to a process of encoding data that have already been encoded and subsequently decoded. The data do not have to be encoded in the same way or in the same layer as for the preceding encoding.

In contrast to a similar method in which the internal network communication element monitors the data transfer in the external network, also referred to as “sniffing,” the monitoring is delegated to the external network communication element. However, the external network communication element is not subject to rights stipulations, so that the rights problem according to the prior art mentioned at the outset is avoided.

Still, the method according to the invention allows communication between the first network element and the second network element, it being possible for the second network element to use dynamic ports. The object of the invention is achieved in this way.

In an example, the encoding of the data can include enveloping the data in at least one protocol shell. Accordingly, the decoding of the data includes removal of this protocol shell. In addition, the re-encoding of the data includes enveloping of the data in at least one protocol shell. The re-encoding of the data is carried out by the internal network communication element, since the internal network communication element can communicate with the second network element within the internal network.

A protocol shell in which the data are packed is a UDP packet or an external bitstream, for example. The protocol shells in which the data are enveloped for the encoding and the re-encoding do not have to be the same protocol shells, or carry the same information.

A distinction is made between the example and a man-in-the-middle (MITM) attack. In an MITM attack, typically the raw data are exchanged in order to send the recipient false data. However, this is not the case in the present invention, since the raw data remain unchanged, and only the protocol shells are exchanged.

The decoding of the data includes removal of all protocol shells.

The data transferred to the second network element are advantageously reduced to a minimum. In the transfer, only the raw data and the protocol shell(s) necessary for the transfer from the internal network communication element to the second network element remain.

The IP communication channel between the external network communication element and the internal network communication element can be a static IP communication channel.

A static IP communication channel uses a fixed IP address that is permanently assigned to a certain network element. This IP address is manually configured, and remains stable provided that no changes are made. With a static IP communication channel, the involved devices may use a predefined IP address to communicate with one another. This type of connectivity is advantageously suited for scenarios in which a constant, reliable connection is necessary, for example for servers, network devices, or certain services that must always be reachable at the same IP address.

The data may be decoded regardless of whether the port, contained in the data encoded by the first network element, is operated by one of the network communication elements.

The external network communication element may advantageously receive the transfer of the data, starting from the first network element, even if the external network communication element does not operate the port specified in the encoding. It may thus be ensured that the external network element picks up all transfers. The data contained in the transfer may then be examined and optionally relayed to the second network element or its service.

The second network element can send a response to the internal network communication element when the second network element does not operate the port that is contained in the data received from the internal network communication element. The internal network communication element relays the response to the external network communication element, and the external network communication element relays the response to the first network element.

The second network element does not operate the port specified in the transfer from the internal network element, for example when the offered service is not available. This may be the case, for example, when the service is offline due to maintenance, or technical problems are present in the second network element.

Since the first network element cannot communicate directly with the second network element, relaying the response of the second network element to the first network element is advantageous, since the first network element is thus informed that the port is not operated by the second network element.

As a response to the transfer of the data by the first network element, the external network communication element can send a protocol-specific response packet to the first network element.

Depending on the type of protocol used, a response to the transfer of the encoded data may be necessary. The external network communication element thus confirms to the first network element that the external network communication element has received the transfer. The protocol-specific response may be designed in particular in such a way that the external network communication element mirrors the behavior of the second network element. In this case, the first network element would not notice that its transfer had not been directly received and responded to by the second network element.

The data can include a connection request by the first network element via a defined port, an indirect connection being established between the first network element and the second network element. In this example, the external network communication element and the internal network communication element relay data between the first network element and the second network element if the connection request was successful.

A constant or continuous connection between the first network element and the second network element may advantageously be established by such a connection request.

The first network element and/or the second network element can receive a loss message concerning the loss of the connection if the connection is terminated or interrupted.

By the receipt of a loss message, it may advantageously be indicated that the connection between the first network element and the second network element has been interrupted. This may advantageously be utilized, for example, to have the first network element resend data to the external network communication element in order to establish a connection with an alternative second network element, which optionally offers a replacement service for the second network element.

The loss message may contain a reason for the loss of the connection.

Different responses may be provided by the first network element, depending on the reason for the loss of the connection. For example, the first network element may be designed to make a new attempt at regular intervals to resume the connection. In other cases, it may be more expedient to contact an alternative second network element to allow use of a fallback service.

The second network element and the internal network communication element can be virtual nodes on a shared system.

The second network element and the internal network element may communicate not via an Ethernet controller, but, rather, via a so-called loopback device, which is a virtual Ethernet controller for local communication.

The first network element and the external network communication element can be virtual nodes on a shared system.

The first network element and the external network element may communicate not via an Ethernet controller, but, rather, via a loopback device.

The implementation of the elements on a shared system advantageously brings about lower latency in the communication between the elements. The data do not have to be transferred via the network, and instead may be exchanged directly between the virtual nodes. This results in faster and more efficient communication.

In addition, a virtual implementation may provide greater security. Since the communication takes place locally via the loopback device, security guidelines and measures may be implemented and controlled more easily. The data remain within the system, and are less susceptible to external attacks or eavesdropping attempts via the network. In addition, even with a virtual implementation a network is formed in which the virtual elements communicate with one another.

In a further aspect, the invention relates to a network system for data transfer, comprising an external network and an internal network. The external network includes at least one first network element and an external network communication element. The external network communication element is designed to monitor the external network.

The internal network can include at least one second network element and an internal network communication element. The second network element can be designed to communicate solely within the internal network.

The external network communication element and the internal network communication element are communicatively connected to one another via an IP communication channel. Furthermore, the external network communication element is designed to process encoded data that are received from the first network element when the port specified in the encoded data is not operated by the external network communication element. The system is also designed to carry out a method as described above.

The method described herein for data transfer in a network system is likewise applicable to the network system according to the invention, and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows the sequence of the method according to an example;

FIG. 2 schematically shows the setup and the communication in a network system according to an example;

FIG. 3 shows an example of a network system; and

FIG. 4 shows a schematic illustration of the encoding and decoding processes.

### DETAILED DESCRIPTION

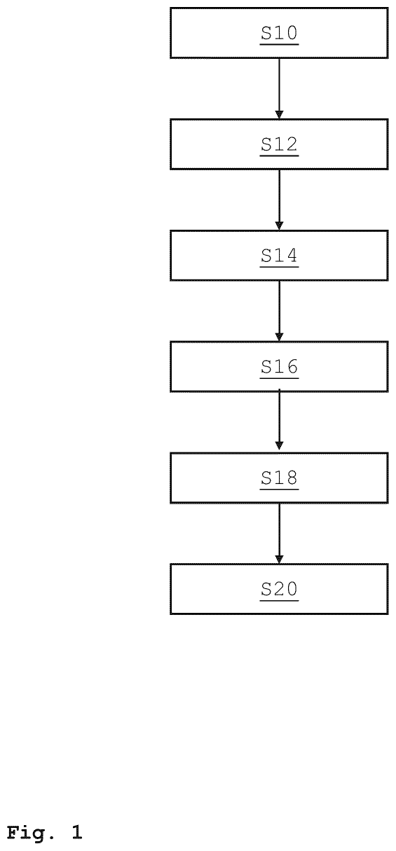

FIG. 1 schematically shows the sequence of the method according to an example. The method begins with step S10, in which a first network element, a consumer client, encodes data. The data are intended for a service, an offered service, that is made available by a second network element, a service provider.

The consumer client is situated in any given first network, and can communicate with all users therein. In contrast, the service provider is situated in a second network in which the users have only limited rights to communication. In particular, the service provider is affected by these limitations, and is not allowed to communicate outside the second network.

After the encoding of the data by the consumer client, the data are transferred to an external network communication element in step S12. The external network communication element monitors the data traffic in the first network and decodes the data of the consumer client, even if the external network communication element does not actually operate the port specified in the encoding.

The external network communication element is communicatively connected to an internal network communication element situated within the second, restrictive network.

The external network communication element transfers the data to the internal communication element in step S14.

In an example, the data are encoded by the external network communication element, i.e., received from the consumer client and relayed to the internal network communication element. In this example, the internal network communication element would decode the data.

The data are re-encoded by the internal network communication element in step S16. This means that the internal network communication element envelops the data in a protocol shell that is suitable for a transfer to the service provider.

In step S18 the re-encoded data are transferred to the service provider, which then decodes them in step S20.

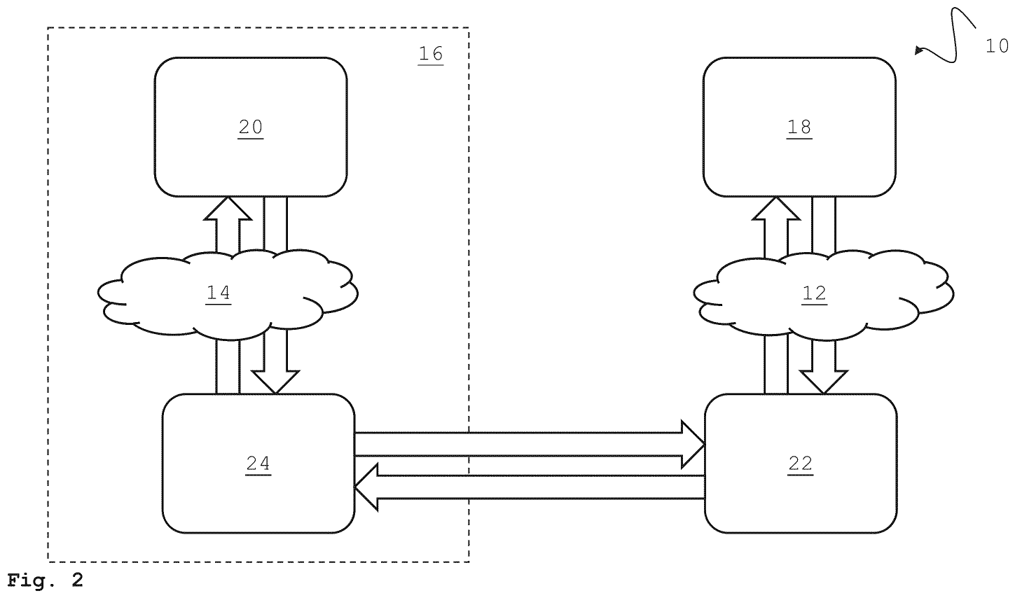

FIG. 2 schematically shows the setup of a network system 10. The network system 10 includes two separate networks 12 and 14. The network 12 may be an open network, for example, in which the users may communicate with one another free of limitations. In contrast, the network 14 is a network in which the users have only limited rights. Only selected users can communicate with users from other networks, who are also subject to strict limitations 16 of communication rights. This may in particular serve as security for the users of the internal network 14.

The method according to the invention is designed so that a first network element 18 from the external network 12 can communicate with a second network element 20 from the internal network 14, although the second network 20 is subject to limitations 16 in communication.

This communication is made possible in that it is performed via an external network communication element 22 in the external network 12, and an internal network communication element 24 in the internal network 14.

The external network communication element 22 is designed to monitor the data that are transferred in the external network 12. In this way, the external network communication element 22 may also receive and process data that are actually addressed to the second network element 20. This process is also referred to as “sniffing.”

A protocol that is specified by the external network 12 may be used between the first network element 18 and the external network communication element 22. The protocol used in the internal network 14 may differ from the protocol of the external network 12. In addition, the second network element 20 may use dynamic ports. The internal network communication element 24 may be designed to ask the port for the application of the second network element 20 before the internal network communication element re-encodes the data and sends them to the second network element 20.

The communication between the external network communication element 22 and the internal network communication element 24 may have an arbitrary design. The external network communication element 22 only needs to be designed to be able to transfer the data received from the first network element 18 to the internal network communication element 24.

The data may, for example, be transferred from the external network communication element 22 to the internal network communication element 24 as raw data. Alternatively, dedicated, protocol-dependent encoding may be used for the transfer between the external network communication element 22 and the internal network communication element 24. In this case, the transfer of the data from the external network communication element 22 to the internal network communication element 24 would include encoding the data by the external network communication element 22 and decoding the data by the internal network communication element 24. The protocol used for the encoding and the decoding must satisfy the protocol used in the IP communication channel.

When the second network element 20 has received and decoded the data, it can process the data according to its application or the service offered by it.

The application or the offered service of the second network element 20 may require a response to the first network element 18. In this case, there can be two options.

According to the first option, a request to set up a communication channel is sent with the first transfer from the first network element 18. If the request is successful, a communication channel is set up between the first network element 18 and the second network element 20 in such a way that the external network communication element 22 and the internal network communication element 24 relay all data between the first network element 18 and the second network element 20.

According to the second option, the proposed method is applied in reverse. That is, the second network element 20 encodes data in order to send them to the first network element 18. However, the first network element 18 is not a communication user in the internal network 14, so that it cannot directly receive the data.

The internal network communication element 24 monitors or “sniffs” the data traffic in the internal network 14, and recognizes the transfer of the second network element 20. Regardless of whether or not the internal network communication element operates in the port contained in the encoding, it accepts the data and responds with an appropriate protocol reply to the second network element 20.

The internal network communication element 24 transmits the data, encoded or unencoded, to the external network communication element 22. The external network communication element 22 in turn mirrors the behavior of the second network element 20 by re-encoding the data and transferring them to the first network element 18.

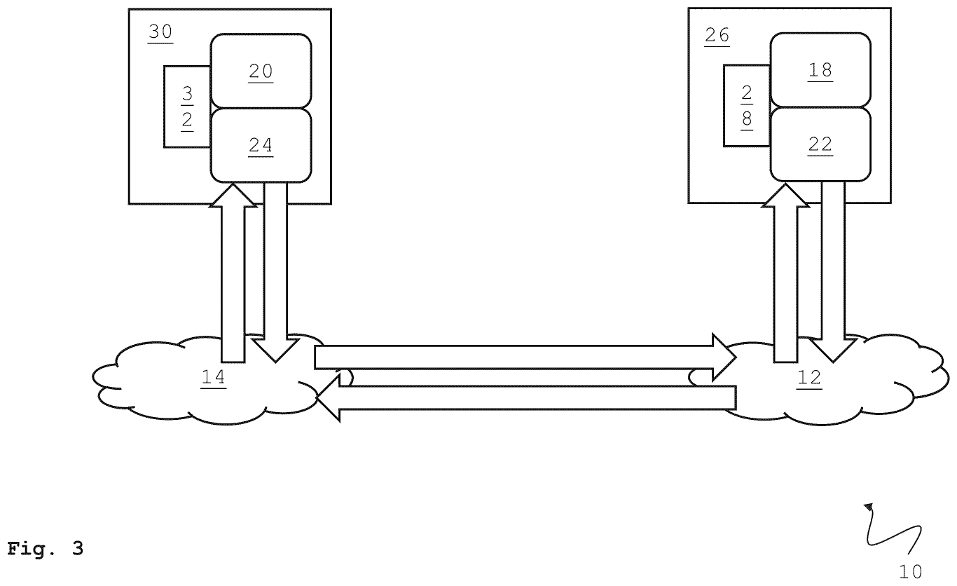

FIG. 3 shows an example in which the network system 10 comprises two networks 12 and 14. In the external network 12 there is at least one system 26 on which a first network element 18 and an external network communication element 22 are operated as two virtual subsystems. The first network element 18 and the external network communication element 22 can communicate with one another via a loopback device 28.

In the internal network 14 there is a system 30 on which a second network element 20, in particular as a service provider, and an internal network communication element 24 are operated. The second network element 20 and the internal network communication element 24 can communicate with one another via a loopback device 32 of the system 30.

In this example, the first network element 18 and the second network element 20 are designed to communicate solely via the respective loopback device 28, 32. The proposed method may be carried out with this design, regardless of how the network elements 18, 20 communicate with the network communication elements 22, 24.

Furthermore, the number of first network elements 18 and second network elements 20 may vary. In addition, any given number of network elements 18, 20 can communicate with the network communication elements 22, 24 via loopback devices 28, 32. In particular, in an example only the first network element 18 and the external network communication element 22 have a loopback device 28. In this example, the second network element 20 and the internal network communication element 24 would be separate systems.

Further, the second network element 20 and the internal network communication element 24 may be combined to form a system 30 with a loopback device 32 in a system 30. In this example the first network element 18 and the external network communication element 22 would be separate systems.

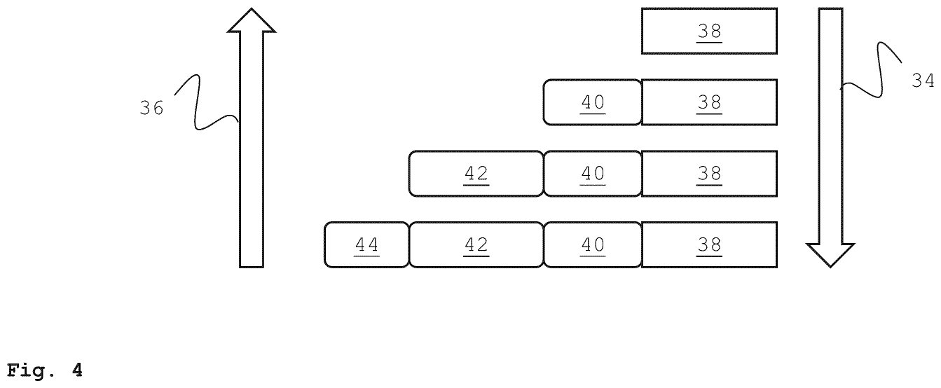

FIG. 4 schematically shows the processes of encoding 34 and decoding 36 a data packet 38.

For the encoding 34, a header which describes how the underlying data structure is to be used is added to the data packet 38. The raw data are situated in the topmost level. In this level the data packet 38 has no header that is relevant to the method.

If the data packet 38 is encoded one level lower, it receives a header 40 for this level. This level may be an application level, for example, so that applications can read the data packet 38 with the information contained in header 40 and/or can process the data packet. Examples of suitable protocols for this level are http, UDS, FTP, SMTP, POP, Telnet, DHCP, OPC UA, TLS, or SOCKS.

The data packet 38 may be further encoded and may penetrate into a lower layer. For the encoding 34, a further header 42 is then added which is prepended to the header 40 from the next higher layer.

This layer may be used, for example, for transporting the data packet 38. Examples of suitable protocols are TCP, UDP, or SCTP.

A layer further down may be the network layer, which for example allows a transfer of the data packet 38 via a network, in particular the internet. For this purpose, a further header 44 is prepended to the header 42 from the overlying layer. Examples of suitable protocols for transferring data in the internet include IP with IPv4 or IPv6, as well as ICMP.

Lastly, a lowest layer may be reached which safeguards the transfer of the data and/or controls on the bit level. A header of this layer would be prepended to the header 44 of the overlying layer.

The headers 40, 42, and 44 may have different lengths, which in particular are a function of the respective protocol used.

For the decoding 36, the headers are removed little by little. Therefore, the decoding 36 in a sense encompasses a translation of the arriving data stream into a data packet 38, which can be appropriately handled for the headers 44, 42, and 40.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for data transfer in a network system comprising an external network and an internal network, the external network including at least one first network element and an external network communication element, the external network communication element being designed to monitor the external network, the internal network including at least one second network element and an internal network communication element, the second network element being designed to communicate solely within the internal network, the external network communication element and the internal network communication element being communicatively connected to one another via an IP communication channel, the method comprising:
encoding, by the first network element, the data to be sent;
transferring the encoded data from the first network element to the external network communication element;
decoding the data by the external network communication element and transferring the data from the external network communication element to the internal network communication element via the IP communication channel or transferring the data from the external network communication element to the internal network communication element via the IP communication channel and decoding the data by the internal network communication element;
re-encoding the data into an application layer by the internal network communication element;
transferring the re-encoded data from the internal network communication element to the second network element; and
decoding the data by the second network element.

2. The computer-implemented method according to claim 1, wherein the data to be sent include a message, the encoding of the data including enveloping of the data in at least one protocol shell, the decoding of the data including removal of at least one protocol shell, the re-encoding of the data by the internal network communication element including enveloping of the data in at least one protocol shell.

3. The computer-implemented method according to claim 2, wherein the decoding of the data includes removal of all protocol shells.

4. The computer-implemented method according to claim 2, wherein the address and/or the port of the second network element have/has been dynamically generated.

5. The computer-implemented method according to claim 1, wherein the IP communication channel between the external network communication element and the internal network communication element is a static IP communication channel.

6. The computer-implemented method according to claim 1, wherein the data are decoded regardless of whether the port, contained in the data encoded by the first network element, is operated by one of the network communication elements.

7. The computer-implemented method according to claim 1, wherein the second network element sends a response to the internal network communication element when the second network element does not operate the port that is contained in the data received from the internal network communication element, wherein the internal network communication element relays the response to the external network communication element, and the external network communication element relays the response to the first network element.

8. The computer-implemented method according to claim 1, wherein as a response to the transfer of the data by the first network element, the external network communication element sends a protocol-specific response packet to the first network element.

9. The computer-implemented method according to claim 1, wherein the data include a connection request by the first network element via a defined port, wherein an indirect connection is established between the first network element and the second network element, and wherein the external network communication element and the internal network communication element relay data between the first network element and the second network element if the connection request was successful.

10. The computer-implemented method according to claim 9, wherein the first network element and/or the second network element receive(s) a loss message concerning the loss of the connection if the connection is terminated or interrupted.

11. The computer-implemented method according to claim 10, wherein the loss message includes a reason for the loss of the connection.

12. The computer-implemented method according to claim 1, wherein the second network element and the internal network communication element are virtual nodes on a shared system.

13. The computer-implemented method according to claim 12, wherein the second network element and the internal network communication element communicate locally with one another via a virtual Ethernet controller.

14. The computer-implemented method according to claim 1, wherein the first network element and the external network communication element are virtual nodes on a shared system.

15. A network system for data transfer, the system comprising:
an external network comprising at least one first network element and an external network communication element, the external network communication element being designed to monitor the external network; and
an internal network comprising at least one second network element and an internal network communication element, the second network element being designed to communicate solely within the internal network, the external network communication element and the internal network communication element being communicatively connected to one another via an IP communication channel,
wherein the external network communication element being further designed to process encoded data that are received from the first network element when a port specified in the encoded data is not operated by the external network communication element, and
wherein the network system being further designed to carry out the method according to claim 1.
